(19) United States
(12) Patent Application Publication
(10) Pub. No.: US 2013/0286320 A1
(43) Pub. Date: Oct. 31, 2013

(54) Middle Frame for LCD Module and LCD device

(71) Applicants: Yicheng Kuo, Shenzhen (CN); Shihhsiang Chen, Shenzhen (CN); Gang Yu, Shenzhen (CN); Gege Zhou, Shenzhen (CN); Weifeng Chen, Shenzhen (CN)

(72) Inventors: Yicheng Kuo, Shenzhen (CN); Shihhsiang Chen, Shenzhen (CN); Gang Yu, Shenzhen (CN); Gege Zhou, Shenzhen (CN); Weifeng Chen, Shenzhen (CN)

(21) Appl. No.: 13/515,521

(22) PCT Filed: May 9, 2012
(86) PCT No.: PCT/CN12/75227

§ 371 Date: Jun. 13, 2012

(30) Foreign Application Priority Data
Apr. 28, 2012 (CN) 201210132956.8

(51) Int. Cl. G02F 1/1333

(52) U.S. Cl. 349/58

(57) ABSTRACT

The invention provides a middle frame for an LCD module and an LCD device. The middle frame for an LCD module includes a plurality of segmented members constituting the middle frame, and further includes a corner member which is arranged on a corner of the middle frame. The corner member is provided with a light blocking wall which is used for blocking a gap in a connecting position between the corner member and the segmented member. In the invention, because the LCD module is divided into a plurality of segmented members, the middle frame can be obtained by only making the same section, and cutting the section to form the segmented members. Thus, the production cost of the middle frame can be saved, and the segmented members of different lengths can be matched to make middle frames of different sizes, thereby saving the cost of moulds. Moreover, the corners of the middle frame are respectively provided with the corner members used for connecting the segmented members, and the corner members are provided with the light blocking wall used for blocking the gap in the connecting position between the segmented member and the corner member. Thus, the corner of the middle frame is prevented from generating a light leakage because of the gap in the connecting position.

### TECHNICAL FIELD

The invention relates to the field of liquid crystal displays (LCDs), and more particularly to a middle frame for an LCD module and an LCD device.

### BACKGROUND

An LCD module is a main component of LCD devices. A conventional LCD module includes a front frame, an LCD panel, a middle frame, an optical film, a light guide panel (LGP), a lightbar, a back cover and the like. The middle frame plays a role of fixing the LGP and supporting the LCD panel. The structures of the middle frames of different LCD devices are similar. The LCD panel is pressed on the middle frame by the front frame and thus fixed.

The middle frame, generally made of plastic material, is also called a rubber frame. Take a rubber frame made of plastic material as an example, because the LCD devices of different sizes require the rubber frames of different sizes, the rubber frames of corresponding sizes must be manufactured according to the LCD devices of different sizes, and thus different moulds are required to be made according to the rubber frames of different sizes. Thus, the manufacture cost of rubber frames is increased.

### SUMMARY

In view of the above-described problems, the aim of the invention is to provide a middle frame for an LCD module and an LCD device that have a low cost and can prevent light leakage.

The aim of the invention is achieved by the following technical scheme.

A middle frame for an LCD module comprises a plurality of segmented members constituting the middle frame, and further comprises a corner member which is arranged on a corner of the middle frame for connecting the segmented members arranged on both sides of the corner. The corner member is provided with a light blocking wall which is used for blocking a gap in a connecting position between the corner member and the segmented member. And the corner member is further provided with a connecting platform which is used for supporting the segmented member in the connecting position between the corner member and the segmented member; the connecting platform is arranged outside the light blocking wall, and an inner side surface of the segmented member is supported on the connecting platform. A height of the connecting platform is lower than that of the light blocking wall, and the height that the connecting platform is lower than the light blocking wall is equal to a thickness of the segmented member. The corner member is further provided with a positioning retaining wall used for positioning the end of the segmented member in the connecting position between the corner member and the segmented member; a height of the positioning retaining wall is higher than that of the connecting platform. The corner member is provided with a supporting platform for supporting an LCD panel.

The aim of the invention is further achieved by the following technical scheme. A middle frame for an LCD module comprises a plurality of segmented members constituting the middle frame, and further comprises a corner member which is arranged on a corner of the middle frame for connecting the segmented members on both sides of the corner; the corner member is provided with a light blocking wall which is used for blocking a gap in a connecting position between the corner member and the segmented member.

Preferably, the corner member is further provided with a connecting platform which is used for supporting the segmented member in the connecting position between the corner member and the segmented member. The connecting platform is arranged outside the light blocking wall, and an inner side surface of the segmented member is supported on the connecting platform. Because the segmented member is supported on the connecting platform, the connecting stability between the segmented member and the corner member is improved, and the structure rigidity of the middle frame is ensured.

Preferably, a height of the connecting platform is lower than that of the light blocking wall, thereby avoiding light leakage when a gap in the connecting position between the segmented member and the corner member is higher than the light blocking wall.

Preferably, the height that the connecting platform is lower than the light blocking wall is equal to a thickness of the segmented member, thereby enabling the structures of the four corners of the middle frame to be flat under the condition of no light leakage, and preventing a prominent structure from forming.

Preferably, the connecting platform is of an L-shaped structure. The L-shaped structure enlarges the supporting area of the connecting platform, improves the connecting stability between the segmented member and the corner member, and improves the structure rigidity of the corner member.

Preferably, the corner member is further provided with a positioning retaining wall used for positioning the end of the segmented member in the connecting position between the corner member and the segmented member; a height of the positioning retaining wall is higher than that of the connecting platform. The positioning retaining wall is used for positioning the end of the segmented member, thus the connecting accuracy between the segmented member and the corner member is improved, and the structure stability of the middle frame is enhanced.

Preferably, the height of the positioning retaining wall is equal to the thickness of the segmented member, to improve the planeness of the corner of the middle frame.

Preferably, the corner member is provided with a supporting platform used for supporting an LCD panel. Thus, the corner member plays a role of supporting the LCD panel, thereby reducing the pressure of the segmented member for supporting the LCD panel, and improving the overall rigidity of the middle frame.

Preferably, the corner member is further provided with a limiting retaining wall used for limiting an edge of the LCD panel, and the supporting platform is arranged inside the light blocking wall. A height of the supporting platform is lower than that of the light blocking wall, and the limiting retaining wall is the light blocking wall. Thus, the LCD panel can be supported, and the edge of the LCD panel can be limited, thereby simplifying the structure of the segmented member.

An LCD device comprises the LCD module mentioned above.

In the invention, because the LCD module is divided into a plurality of segmented members, the middle frame can be obtained by only making the same section, and cutting the section to obtain the segmented members. Thus, the mould manufacture cost and production cost of the middle frame can be greatly saved, and the segmented members of different lengths can be matched to manufacture the middle frames of different sizes. Therefore, there is no need to manufacture different moulds according to the middle frames of different sizes, and then the mould cost is saved. Moreover, the corners of the middle frame are respectively provided with the corner members used for connecting the segmented members, and the corner members are provided with a light blocking wall which is used for blocking a gap in a connecting position between the segmented member and the corner member. Thus, the corner of the middle frame is prevented from generating a light leakage because of the gap in the connecting position.

### BRIEF DESCRIPTION OF FIGURES

FIG. 1 is a partial view of a corner of a middle frame of an example of the invention;

FIG. 2 is a simplified structure diagram of a corner member of a middle frame of an example of the invention; and

FIG. 3 is a simplified structure diagram of a corner member matched with a segmented member of an example of the invention.

Legends: 1. corner member; 2. segmented member; 5. LCD panel; 10. light blocking wall; 11. connecting platform; 12. positioning retaining wall; 13. supporting platform; 14. limiting retaining wall.

### DETAILED DESCRIPTION

The invention will further be described in detail in accordance with the figures and the preferable examples.

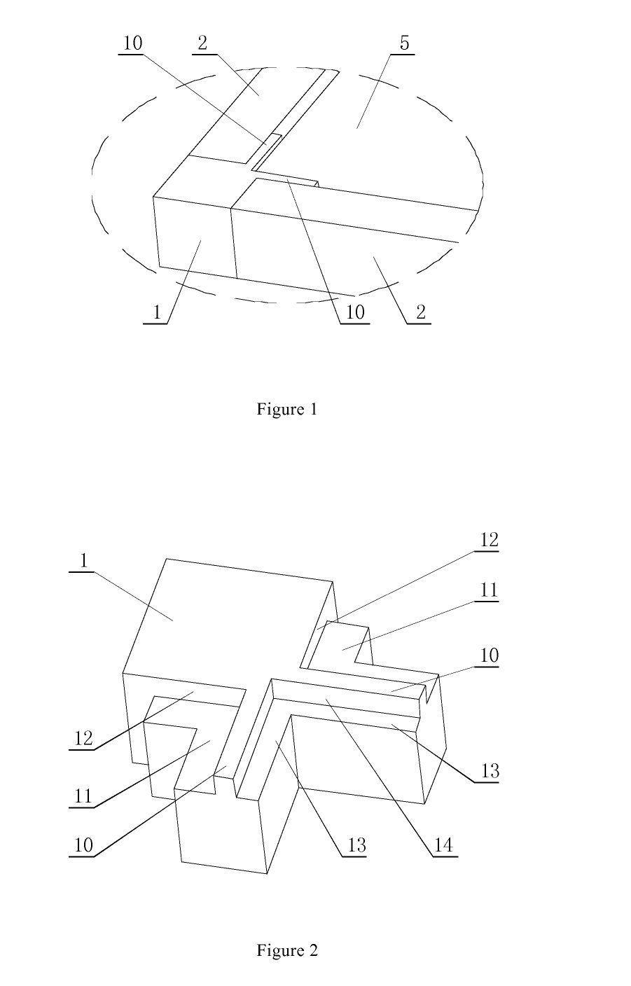

FIG. 1 shows a middle frame for an LCD module of an LCD device of the invention. The middle frame comprises a plurality of segmented members 2 which constitute a frame structure of the middle frame and are formed by cutting a same section, and a corner member 1 which is used for connecting the segmented members 2 on both sides of the four corners. The corner member 1 is provided with a light blocking wall 10 which is used for blocking a gap in a connecting position between the corner member 1 and the segmented member 2, and the end of the segmented member 2 is positioned outside the light blocking wall. Thus, the LCD panel 5 is separated from the gap formed in the connecting position between the segmented member 2 and the corner member 1 by the light blocking wall 10, and light is prevented from leaking from the gap.

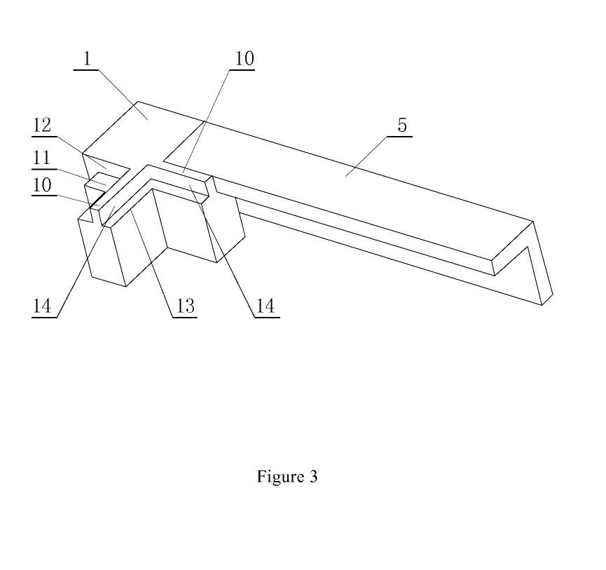

As shown in FIGS. 2 and 3, the corner member 1 comprises the light blocking wall 10 arranged at two sides of the corner member 1. The angle between two light blocking walls is 90°, which corresponds two adjacent side frames of the middle frame (namely the segmented member). The corner member 1 is further provided with a connecting platform 11 used for supporting the segmented member, and the connecting platform 11 is arranged outside the light blocking wall 10 to form a step structure on the corner member 1. When the segmented members 2 are connected and matched by the corner members 1 in the four corners of the middle frame, an inner side surface of the ends of the segmented members are supported on the connecting platforms 11. Because the connecting platform 11 is positioned outside the light blocking wall 10, the gap in the connecting position between the segmented member 2 and the corner member 1 is blocked by the light blocking wall 10, thereby preventing light from leaking from the gap. Optionally, the connecting position between the corner member 1 and the segmented members 2 can further be provided with certain hook structures, or other locking structures such as a threaded hole, a slot, etc., to enable the corner member 1 to be fixedly connected with the segmented members 2. Thus, the overall structure rigidity of the middle frame is improved.

A height of the connecting platform 11 should be lower than that of the light blocking wall 10, thereby avoiding to generate partial light leakage gap in the connecting position between the segmented member 2 and the corner member 1 because the segmented member 2 is higher than the light blocking wall 10 when the inner side surface of the end of the segmented member 2 is supported on the connecting platform 11. Preferably, the height that the connecting platform 11 is lower than the light blocking wall 10 is equal to a thickness of the segmented member 2, thereby guaranteeing the gap to be fully blocked by the light blocking wall 10 to avoid light leakage, and enabling a corner region of the middle frame to be flat without a protrusion.

As shown in the Figure, the connecting platform 11 is of an L-shaped structure; thus, the contact area between the connecting platform 11 and the segmented member 2 is increased, and thus the structure rigidity of the corner region of the middle frame is improved.

The corner member 1 is further provided with a positioning retaining wall 12 used for positioning an end of the segmented member 2, and the positioning retaining wall 12 is a connecting surface of the connecting position between the corner member 1 and the segmented member 2. The positioning retaining wall 12 is mutually perpendicular to the light blocking wall 10, and a height of the positioning retaining wall 12 is higher than that of the connecting platform 11. A gap between the segmented member 2 and the positioning retaining wall 12 of the corner member 1 is blocked by the light blocking wall 10, and then light is prevented from leaking from the gap. Optionally, the height of the positioning retaining wall 12 can be equal to the thickness of the segmented member 2. Thus, the protrusion is prevented from generating on the corner region of the middle frame, and a planeness of the middle frame is guaranteed.

Combined with FIG. 1, the corner member 1 is further provided with a supporting platform 13 used for supporting an LCD panel of the LCD module, and a limiting retaining wall 14 used for limiting an edge of the LCD panel. The supporting platform 13 is positioned inside the light blocking wall 10. A height of the supporting platform 13 is lower than that of the light blocking wall 10. Thus, a structure used for limiting the edge of the LCD panel is formed on the upper part of the light blocking wall 10, namely the limiting retaining wall 14. Thus, the corner member 1 plays a role of supporting the LCD panel 5, and thus reduces the pressure of the segmented member 2 used for supporting the LCD panel 5, and improves the overall rigidity of the middle frame.

The above examples are described by referring to the figures to illustrate the specific examples of the invention. The direction expressions mentioned in the invention such as inside, outside, side, etc. only show the directions in the Figures as reference. Therefore, the used direction expressions are used for describing and explaining the invention. However, the direction expressions are not used for limiting the invention.

The invention is described in detail in accordance with the above contents with the specific preferred examples. However, this invention is not limited to the specific examples. For the ordinary technical personnel of the technical field of the invention, on the premise of keeping the conception of the invention, the technical personnel can also make simple deductions or replacements, and all of which should be considered to belong to the protection scope of the invention.

We claim:

1. A middle frame for an LCD module, comprising: a plurality of segmented members constituting said middle frame, and a corner member which is arranged on a corner of said middle frame and used for connecting the segmented members on both sides of said corner; wherein said corner member is provided with a light blocking wall used for blocking a gap in a connecting position between said corner member and said segmented member, and is further provided with a connecting platform used for supporting said segmented member in the connecting position between said corner member and said segmented member; said connecting platform is arranged outside said light blocking wall, and an inner side surface of said segmented member is supported on said connecting platform; a height of said connecting platform is lower than that of said light blocking wall, and the height that said connecting platform is lower than said light blocking wall is equal to a thickness of said segmented member; said corner member is further provided with a positioning retaining wall used for positioning the end of said segmented member in the connecting position between said corner member and said segmented member, and a height of said positioning retaining wall is higher than that of said connecting platform; said corner member is provided with a supporting platform used for supporting an LCD panel.

2. A middle frame for an LCD module, comprising: a plurality of segmented members constituting said middle frame, and a corner member which is arranged on a corner of said middle frame and used for connecting said segmented members on both sides of said corner; wherein said corner member is provided with a light blocking wall used for blocking a gap in a connecting position between said corner member and said segmented member.

3. The middle frame for an LCD module of claim 2, wherein said corner member is further provided with a connecting platform used for supporting said segmented member in the connecting position between said corner member and said segmented member, said connecting platform is arranged outside said light blocking wall, and an inner side surface of said segmented member is supported on said connecting platform.

4. The middle frame for an LCD module of claim 3, wherein a height of said connecting platform is lower than that of said light blocking wall.

5. The middle frame for an LCD module of claim 4, wherein the height that said connecting platform is lower than said light blocking wall is equal to a thickness of said segmented member.

6. The middle frame for an LCD module of claim 4, wherein said connecting platform is of an L-shaped structure.

7. The middle frame for an LCD module of claim 3, wherein said corner member is further provided with a positioning retaining wall used for positioning the end of said segmented member in the connecting position between said corner member and said segmented member; a height of said positioning retaining wall is higher than that of said connecting platform.

8. The middle frame for an LCD module of claim 7, wherein the height of said positioning retaining wall is equal to a thickness of said segmented member.

9. The middle frame for an LCD module of claim 2, wherein said corner member is provided with a supporting platform used for supporting an LCD panel.

10. The middle frame for an LCD module of claim 9, wherein side of said corner member is further provided with a limiting retaining wall used for limiting an edge of said LCD panel, and the supporting platform is arranged inside said light blocking wall; a height of said supporting platform is lower than that of said light blocking wall, and said limiting retaining wall is said light blocking wall.

11. An LCD device, comprising: a middle frame; wherein said middle frame comprises a plurality of segmented members constituting said middle frame, and further comprises a corner member which is arranged on a corner of said middle frame and used for connecting said segmented members on both sides of said corner; said corner member is provided with a light blocking wall used for blocking a gap in a connecting position between said corner member and said segmented member.

12. The LCD device of claim 11, wherein side of said corner member is further provided with a connecting platform used for supporting said segmented member in the connecting position between said corner member and said segmented member, said connecting platform is arranged outside of said light blocking wall, and an inner side surface of said segmented member is supported on said connecting platform.

13. The LCD device of claim 12, wherein a height of said connecting platform is lower than that of said light blocking wall.

14. The LCD device of claim 13, wherein the height that said connecting platform is lower than said light blocking wall is equal to a thickness of said segmented member.

15. The LCD device of claim 13, wherein said connecting platform is of an L-shaped structure.

16. The LCD device of claim 12, wherein said corner member is further provided with a positioning retaining wall used for positioning an end of said segmented member in the connecting position between said corner member and said segmented member; and a height of said positioning retaining wall is higher than that of said connecting platform;

17. The LCD device of claim 16, wherein the height of said positioning retaining wall is equal to a thickness of said segmented member.

18. The LCD device of claim 11, wherein said corner member is provided with a supporting platform used for supporting said LCD panel.

19. The LCD device of claim 18, wherein side of said corner member is further provided with a limiting retaining wall used for limiting an edge of an LCD panel, and said supporting platform is arranged inside of said light blocking wall; a height of said supporting platform is lower than that of said light blocking wall, and said limiting retaining wall is said light blocking wall.
